(19) United States
(12) Patent Application Publication
(10) Pub. No.: US 2016/0269940 A1
(43) Pub. Date: Sep. 15, 2016

(54) CENTRAL CONTROL STATION, RADIO BASE STATION AND RADIO COMMUNICATION CONTROL METHOD

(71) Applicant: NTT DOCOMO, INC., Tokyo (JP)

(72) Inventors: Kazuaki Takeda, Tokyo (JP); Jing Wang, Beijing (CN); Liu Liu, Beijing (CN); Yu Jiang, Beijing (CN); Huiling Jiang, Beijing (CN)

(73) Assignee: NTT DOCOMO, INC., Tokyo (JP)

(21) Appl. No.: 15/032,751

(22) PCT Filed: Oct. 17, 2014
(86) PCT No.: PCT/JP2014/077641

§ 371 Date: Apr. 28, 2016

(30) Foreign Application Priority Data
Oct. 31, 2013 (JP) 2013-227412

(51) Int. Cl. H04W 28/16; H04W 24/02; H04W 88/12

(52) U.S. Cl. CPC H04W 28/16; H04W 88/12; H04W 24/02; H04W 88/02

(57) ABSTRACT

The present invention is designed to reduce the decrease of system performance when coordinated multi-point transmission is carried out to a user terminal. The central control station of the present invention provides a central control station that is connected with a plurality of radio base stations that carry out coordinated multi-point transmission to a user terminal, and this central control station has a reporting information generating section that generates, for each radio base station, information about radio resources allocated to other radio base stations that carry out coordinated multi-point transmission, and a reporting section that reports the information about the radio resources, generated in the reporting information generating section, to each radio base station.

### TECHNICAL FIELD

The present invention relates to a central control station, a radio base station and a radio communication method in a next-generation mobile communication system.

### BACKGROUND ART

LTE (Long Term Evolution) and successor systems of LTE (referred to as, for example, “LTE-A (LTE-Advanced),” “FRA (Future Radio Access),” “4G,” etc.) are under study for the purpose of achieving improved communication throughput (see, for example, non-patent literature 1).

In such communication systems, studies related to inter-cell orthogonalization techniques are in progress for the purpose of achieving further improvement of system performance. In 3GPP (3rd Generation Partnership Project), coordinated multi-point (CoMP: Coordinated Multi-Point) transmission/reception is under study as a technique for implementing inter-cell orthogonalization. In CoMP transmitting/reception, a plurality of transmitting/receiving points coordinate and carry out transmitting/receiving signal processing for one or a plurality of user terminals. To be more specific, for down link communication, simultaneous transmission by multiple cells employing pre-coding, coordinated scheduling/cooperated beam forming and so on are under study.

### CITATION LIST

### Non-Patent Literature

Non-Patent Literature 1: 3GPP TR 36.814 “Evolved Universal Terrestrial Radio Access (E-UTRA); Further Advancements for E-UTRA Physical Layer Aspects”

### SUMMARY OF INVENTION

### Technical Problem

As a structure to allow a plurality of transmission points to carry out CoMP transmission to a user terminal, there is a structure in which a predetermined control station controls a plurality of transmission points in a centralized manner (centralized control structure). When, in a centralized control structure, a focus is placed on reducing the volume of communication between the control station and a transmission point, control is implemented so that radio resource allocation information for scheduler control is reported from the control station to the transmission point, which has a radio resource scheduler. In this case, the transmission point carries out scheduling and MCS (Modulation and Coding Scheme)-based data modulation for the user terminals that are present in the cell formed by the subject station, based on the radio resource allocation information, channel state information (CSI) from the user terminals and so on, and communicates with the user terminals.

However, in a conventional centralized control structure for reducing the volume of communication, a transmission point knows only radio resource allocation information that pertains to the subject station, and, when a user terminal reports CSI, the transmission point is unable to decide what signals were multiplexed in the radio resource that was measured to derive the CSI. For example, it is difficult for an individual transmission point to decide on its own whether the CSI was derived by measuring radio resources where signals from the subject station alone are allocated, or derived by measuring radio resources where signals from the subject station and signals from other CoMP-coordinated cells are allocated.

If the transmission point makes the above decision wrong, the transmission point has to carry out processes based on channel states that are different from what they really are. As a result of this, the scheduling and data modulation for user terminals engaged in CoMP transmission become inadequate, and there is a threat that the system performance decreases.

The present invention has been made in view of the above, and it is therefore an object of the present invention to provide a central control station, a radio base station and a radio communication control method which can prevent the decrease of system performance when coordinated multi-point transmission is carried out to user terminals.

### Solution to Problem

The central control station of the present invention provides a central control station that is connected with a plurality of radio base stations that carry out coordinated multi-point transmission to a user terminal, and this central control station has a reporting information generating section that generates, for each radio base station, information about radio resources allocated to other radio base stations that carry out coordinated multi-point transmission, and a reporting section that reports the information about the radio resources, generated in the reporting information generating section, to each radio base station.

### Advantageous Effects of Invention

According to the present invention, it is possible to reduce the decrease of system performance when coordinated multi-point transmission is carried out to user terminals.

### BRIEF DESCRIPTION OF DRAWINGS

FIG. 1 provide diagrams to explain coordinated multi-point transmission by way of simultaneous transmission by multiple cells;

FIG. 2 provide diagrams to explain a centralized control structure in coordinated multi-point transmission;

FIG. 3 is a conceptual diagram of a network structure where a radio communication control method according to the present embodiment is employed;

FIG. 4 is diagram to show an example of radio resource allocation information in an example 1 of the radio communication control method according to the present embodiment;

FIG. 5 is a diagram to show an example of a network structure in which the radio communication control method according to the present embodiment is employed;

FIG. 6 is a diagram to show an example of information about radio resources allocated to neighboring radio base stations in an example 2.1 of the radio communication control method according to the present embodiment;

FIG. 7 is a diagram to show an example of information about radio resources allocated to neighboring radio base stations in an example 2.3 of the radio communication control method according to the present embodiment;

FIG. 8 is a diagram to show an example of a network structure in which the radio communication control method according to the present embodiment is employed;

FIG. 9 is a diagram to show an example of information about radio resources allocated to neighboring radio base stations in a variation based on example 2.1 of the radio communication control method according to the present embodiment;

FIG. 10 is a diagram to show an overall structure of a radio communication system according to the present embodiment;

FIG. 11 is a block diagram to show an example structure of a central control station according to the present embodiment; and

FIG. 12 is a block diagram to show an example structure of a radio base station according to the present embodiment.

### DESCRIPTION OF EMBODIMENTS

Now, an embodiment of the present invention will be described below in detail with reference to the accompanying drawings.

First, downlink CoMP transmission will be described. Downlink CoMP transmission includes coordinated scheduling/coordinated beamforming (CS/CB), and joint processing (JP). CS/CB refers to the method in which only one transmission point carries out transmission to one user terminal, and is the method to allocate radio resources in the frequency/space domain by taking into account interference from other cells and interference against other cells.

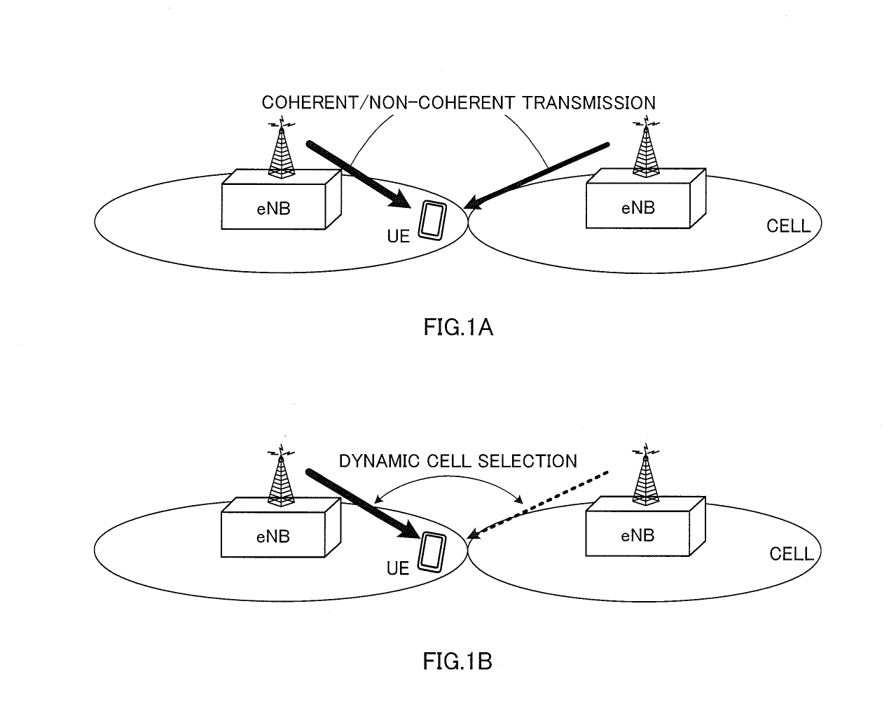

Meanwhile, JP refers to the method in which multiple cells carry out transmission simultaneously by employing precoding. FIG. 1 provide diagrams to explain coordinated multi-point transmission by way of simultaneous transmission by multiple cells, and illustrate how signals are transmitted from radio base stations (eNBs: eNodeBs) to a user terminal (UE: User Equipment). JP includes joint transmission (JT), in which transmission is carried out from a plurality of cells to one user terminal as shown in FIG. 1A, and dynamic point selection (DPS), in which cells are selected dynamically as shown in FIG. 1B.

Two structures are possible as structures to implement CoMP transmission/reception. The first one is the centralized control structure, in which a control station is connected with a plurality of transmission points, and this control station controls CoMP all together. The second is the autonomous distributed control structure, in which a plurality of transmission points are connected with each other and execute control separately. Here, the transmission points may be radio base stations (eNBs: eNodeBs), or may be remote radio heads (RRHs).

The structure to implement CoMP transmission in the present embodiment is the centralized control structure. In the centralized control structure, a plurality of transmission points are controlled in a control station in a centralized manner, so that it is possible to carry out radio resource control between cells in the control station all together.

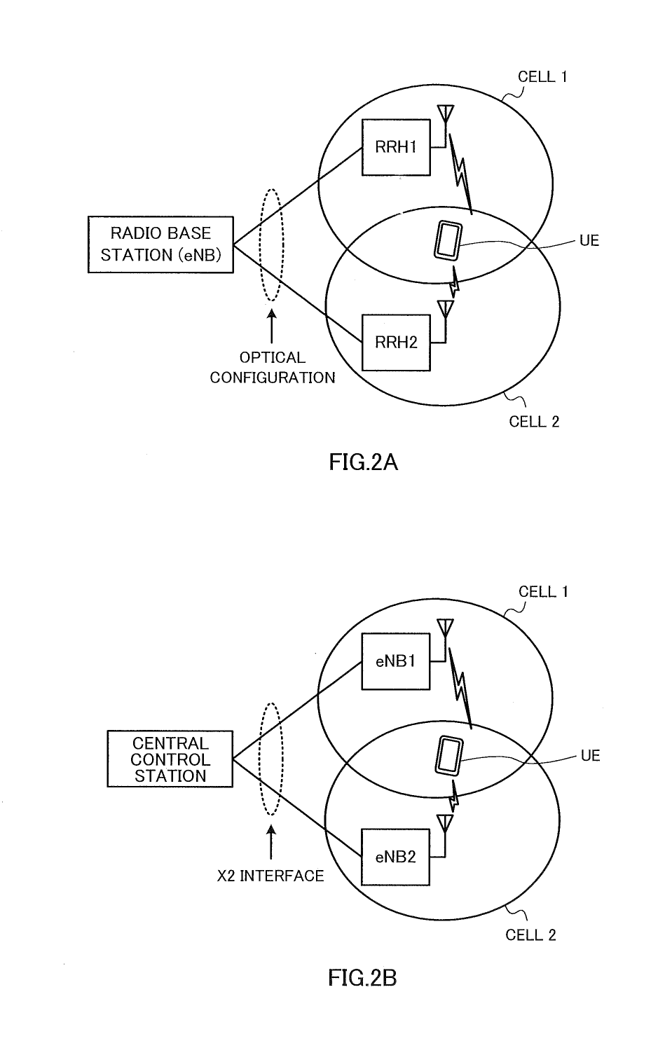

FIG. 2 provide diagrams of a centralized control structure in CoMP transmission. FIG. 2A shows a structure in which a radio base station (eNB) and a plurality of remote radio heads (RRH) carrying out CoMP transmission are connected via an optical configuration (optical fiber). CoMP in which such a high-speed and a high-capacity backhaul channel like this optical configuration is used that transmission points to carry out CoMP transmission (in this example, the RRHs) and the apparatus to carry out control (in this example, the eNB) can be seen as one and the same is also referred to as “ideal backhaul CoMP.”

In ideal backhaul CoMP, the control station can carry out baseband signal processing for a plurality of transmission points based on information such as channel state information (CSI) acquired in each transmission point, and transmit baseband signals to each transmission point directly. Optical fiber enables high-speed and high-capacity communication, makes the problems of propagation delays and communication overhead insignificant, and makes high-speed radio resource control between cells relatively easy. Consequently, optical configuration is suitable for high-speed inter-cell signal processing such as simultaneous transmission by multiple cells on the downlink.

Now, “CSI” is information about the channel states of radio links between transmission points and user terminals. Optimal scheduling in the time domain/frequency domain/space domain is executed based on CSI fed back from user terminals. Parameters to constitute CSI include PMIs (Precoding Matrix Indicators), which are associated with the amount of phase/amplitude control to be configured in the antennas of the transmitter (also referred to as “precoding matrix,” “precoding weight,” etc.) and radio link quality information (CQI: Channel Quality Indicators) for use in the adaptive modulation/demodulation and coding process (AMC: Adaptive Modulation and Coding Scheme).

Also, a structure to use the X2 interface instead of optical fiber is also under study. The X2 interface has low communication speeds compared to optical fiber, but enables cost reduction. On the other hand, from the perspective of executing dynamic communication control, the X2 interface has low speeds compared to optical fiber, and has difficulty transmitting baseband signals from the control station to the transmission points directly. Consequently, when the X2 interface is used, the transmission points are provided with radio resource schedulers, and information for scheduler control is reported from the control station, thereby coordinating between cells.

FIG. 2B shows an example structure to connect between a control station and transmission point via the X2 interface. In FIG. 2B, a central control station (CU: Centralized Unit) and radio base stations with schedulers are connected via the X2 interface. In this way, CoMP with a low-speed or a low-capacity backhaul channel is also referred to as “non-ideal backhaul CoMP.”

In non-ideal backhaul CoMP, information that is acquired in each transmission point such as CSI is collected in the central control station, and the central control station generates radio resource allocation information for each transmission point, and reports this information to each transmission point. Each transmission point independently controls scheduling and data modulation based on the subject station's radio resource allocation information reported from the central control station, CSI that is fed back from user terminals and so on.

Here, the radio resource allocation information refers to timing information and scheduling information related to the allocation of radio resources. The radio resource allocation information is information that indicates, for example, whether or not to place radio resources in the muted state or in the normal state, per physical resource block (PRB). Here, when the radio resource of a given PRB or subband is in the muted state in a given transmission point, this means that this transmission point does not carry out transmission using this radio resource (that is, the transmission power is made zero). On the other hand, if the radio resource is in the normal state, the transmission point transmits signals using this radio resource. Note that it is equally possible to schedule the transmission point not to transmit signals in radio resources that are indicated to be in the normal state.

As a technique to place radio resources in the muted state, there is, for example, PDSCH muting, which places given PRBs of a physical downlink shared channel (PDSCH) in the muted state. Also, as a method of estimating the locations of PRBs that are subject to PDSCH muting, the zero-power CSI-RS configuration can be used, whereby the radio resources where the CSI-RS (Channel State Information Reference Signal), which is a channel state measurement signal, may be placed, can be made zero power. By this means, it is possible to realize flexible channel estimation and interference estimation assuming various types of CoMP transmission.

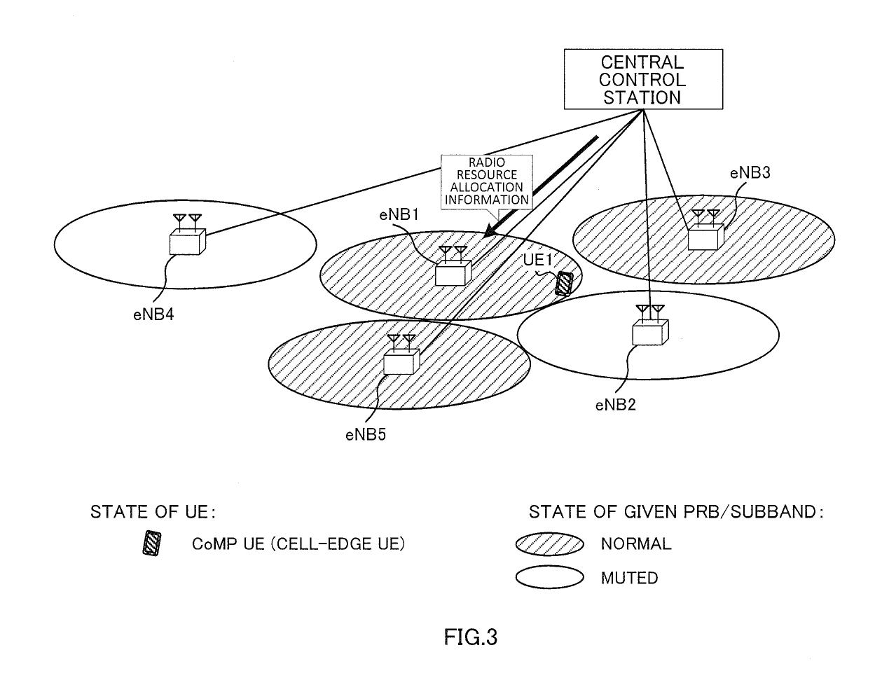

FIG. 3 shows a conceptual diagram of a network structure where the radio communication control method according to the present embodiment is employed. The network structure shown in FIG. 3 includes radio base stations (eNB 1 to eNB 5) that form cells, a user terminal (UE 1) that communicates with the radio base stations and a central control station that is connected with each radio base station via the X2 interface.

In the network structure shown in FIG. 3, the central control station is connected with a core network. The central control station may be, for example, an access gateway apparatus, a radio network controller (RNC), a mobility management entity (MME) and so on, but is by no means limited to these.

Note that the present embodiment is no means limited to the network structure shown in FIG. 3. For example, the radio base stations may be connected via the X2 interface. Also, the user terminal in the present embodiment may be either a mobile terminal apparatus or a stationary terminal apparatus.

In FIG. 3, UE 1 is a UE that is subject to CoMP (CoMP UE) and is present on a cell edge of eNB 1. Also, in FIG. 3, the state of a given PRB/subband in each radio base station in a given unit time is shown, where eNB 1, eNB 3 and eNB 5 are in the normal state, and eNB 2 and eNB 4 are in the muted state.

In FIG. 3, the central control station collects, from eNB 1 to eNB 5, information about the UEs that are present in the cell formed by each radio base station, and measurement results such as the RSRP (Reference Signal Received Power) and so on that are reported from the UEs with respect to multiple cells, on a regular basis or at predetermined timings, via the backhaul. Then, the central control station determines the UE to be subject to CoMP by using the collected information, and reports higher layer parameters that are necessary for CoMP to each radio base station. In this case, the central control station determines whether or not to apply CoMP, and generates higher layer parameters.

On the other hand, it may also be possible that each radio base station determines whether or not to apply CoMP based on measurement results from UEs, and generate higher layer parameters. In this case, each radio base station reports signaling for requesting information about nearby radio base stations, which is required in CoMP, to the central control station, via the backhaul. The central control station reports, in response to the request signal, information about nearby radio base stations that is required in CoMP (for example, configurations related to the CSI-RSs and IMRs (interference signal power measurement resources) used in nearby radio base stations, virtual cell IDs, etc.) to the radio base station, via the backhaul.

Also, each radio base station configures higher layer parameter that are required in CoMP, in the UE. The UE feeds back CSI information for CoMP to the serving cell, and these pieces of information are collected in the central control station via the backhaul. The central control station determines each radio base station's radio resource allocation based on the CSI information and so on, and reports radio resource allocation information to each radio base station.

In FIG. 3, eNB 1 forming the cell accommodating UE 1 and eNB 2 and eNB 3 forming cells that neighbor UE 1 are controlled to coordinate and carry out CoMP transmission with respect to UE 1. The central control station generates radio resource allocation information for each of eNBs 1 to 3, and reports this information. Each radio base station independently controls scheduling, data modulation and so on, based on the radio resource allocation information for the subject station reported from the central control station, CSI that is fed back from the user terminal, and so on.

UE 1, being subject to CoMP, needs to measure the channel states of the cells formed by eNB 1 to eNB 3, and feed back CSI to one of the eNBs. In this case, eNB 1 to eNB 3 are the measurement set, and the measurement set size is three.

Note that channel states can be measured by using reference signals that are arranged in predetermined radio resources. Here, the CSI-RS, the CRS (Cell-specific Reference Signal) and so on of the LTE-A system may be used as the reference signals to use in the channel state measurements. Also, it is equally possible to report CSI-RS resources (also referred to as “SMRs” (Signal Measurement Resources)) and interference signal power measurement resources (CSI-IM (Interference Measurement) resources, also referred to as “IMRs”) to the user terminal, by applying PDSCH muting. Note that the combination of SMRs and IMRs is also referred to as “CSI process.”

Also, information about the measurement set and the measurement set size may be configured to be reported between the central control station, the radio base stations and the user terminal as appropriate. Also, the information to be fed back from the user terminal may include the reference signal received power (RSRP: Reference Signal Received Power), reference signal received quality (RSRQ: Reference Signal Received Quality) and so on.

Here, for example, a case will be considered in which UE 1 can return the following three types of CSI (which, for ease of explanation, will be referred to as “CSI 1,” “CSI 2,” and “CSI 3”). CSI 1 is the CSI for use in the non-CoMP transmission state (single-cell communication), and, for example, CSI for radio resources where eNB 1, eNB 2 and eNB 3 are in the normal state. Also, CSI 2 is the CSI (CoMP CSI) for use in the CoMP transmission, and is CSI for radio resources where eNB 1 is in the normal state, eNB 2 is in the muted state and eNB 3 is in the normal state. Also, CSI 3 is CoMP CSI for radio resources where eNB 1 and eNB 2 are in the normal state and eNB 3 is in the muted state.

In the example of FIG. 3, eNB 1, eNB 3 and eNB 5 are in the normal state and eNB 2 and eNB 4 are in the muted state, with respect to a given PRB to be allocated to UE 1, and CSI 2 is the CSI UE 1 feeds back. Nevertheless, since, in conventional systems, eNB 1 has no information as to whether eNB 2 and eNB 3 are in the muted state or the in the normal state, eNB 1 cannot properly decide which of CSI 1 to CSI 3 the CSI that is fed back from UE 1.

As described above, in a radio communication system in which non-ideal backhaul CoMP is executed (for example, see above FIG. 2B), given that the central control station reports, to each radio base station, only the radio resource allocation information for use for that radio base station, when CSI is fed back from a user terminal, a radio base station cannot properly decide whether signals from other cells were multiplexed in the radio resource that was measured to derive the CSI. Consequently, there is a threat that adequate scheduling and data modulation cannot be performed with respect to UEs that are subject to CoMP and the system performance decreases.

So, the present inventors have come up with the idea of allowing the central control station to report, to a radio base station, not only radio resource allocation information for use for that radio base station, but also information about radio resources allocated to other radio base stations that carry out coordinated multi-point transmission, so that, when CSI is fed back from a user terminal, the radio base station can properly decide what signals were multiplexed in the radio resource that was measured to derive the CSI. According to this structure, even in non-ideal backhaul CoMP of the centralized control structure, it is possible to reduce the decrease of system performance.

Note that the present embodiment may assume a structure to use, instead of the central control station, a radio base station having the functions of a central control station. In this case, a specific radio base station among a plurality of radio base stations may be provided with the functions of a central control station. Also, a structure may be possible in which remote radio heads (RRE: Remote Radio Equipment) having radio resource scheduling functions are used, instead of eNBs, as transmission points. Also, the radio communication control method according to the present embodiment may be applied to any CoMP transmission scheme. Also, the present embodiment is applicable not only to non-ideal backhaul CoMP, but also to ideal backhaul CoMP as well.

Now, the radio communication control method according to the present embodiment will be described in detail below. In the radio communication control method according to the present embodiment, the information about radio resources allocated to other radio base stations that carry out coordinated multi-point transmission is roughly divided into radio resource allocation information of other radio base stations (example 1), and information about the state of interference in the radio base station to which this information is reported (example 2). Each example will be described below.

### Example 1

In an example 1 of the radio communication control method according to the present embodiment, the central control station reports, to a radio base station, as information about radio resources allocated to neighboring radio base stations that carry out CoMP transmission, radio resource allocation information in these neighboring radio base stations, along with identification information of the cells formed by these neighboring radio base stations. According to example 1, the radio base station to which this reporting is directed can properly decide whether or not the neighboring radio base stations are transmitting signals in given radio resources, and, when CSI is fed back from a user terminal, properly decide what signals were multiplexed in the radio resource that was measured to derive the CSI.

Note that, with the present embodiment, a neighboring radio base station means another radio base station carrying out CoMP transmission. For example, when there are two radio base stations that do not carry out CoMP transmission, even if the distance between the radio base stations is short, these are not neighboring radio base stations to each other.

In example 1, in addition to the radio resource allocation information of the radio base station to which the reporting is directed, radio resource allocation information of neighboring radio base stations is also reported. For the radio resource allocation information, a bit sequence, in which every one bit represents the muted state/normal state of every physical resource block (PRB) in one radio base station may be used. Also, the length of this bit sequence is the number of PRBs to constitute the bandwidth which the radio base station uses in CoMP. The radio resource allocation information of neighboring radio base stations is associated with identification information of the cells formed by these neighboring radio base stations (for example, cell IDs), and configured so that the radio base station can decide which radio resource allocation information pertains to which neighboring radio base station.

Note that the bandwidth which the radio base station uses in CoMP may be the same as the system bandwidth or may be part of the system bandwidth. Also, the central control station can report radio resource allocation information pertaining to part of the PRBs in the bandwidth which the radio base station uses in CoMP. Also, if states to represent radio resources other than the muted state/normal state are stipulated, a bit sequence may be used in which a plurality of bits, not one bit, represent the state of each PRB. Also, example 1 may be structured so that, not only identification information of the cells formed by neighboring radio base stations, but also identification information of the cell formed by the radio base station to which the reporting is directed is reported from the central base station to the radio base station when the radio resource allocation information of this radio base station is reported.

The bit sequence to represent the above radio resource allocation information in example 1 may assume a signal format to resemble the RNTP (Relative Narrow-band Transmit Power), which is used as an interference control signal. The RNTP is the signal which a given radio base station uses to report a bit sequence showing the value “0” or “1” per PRB, depending on the downlink signal transmission power, to other radio base stations.

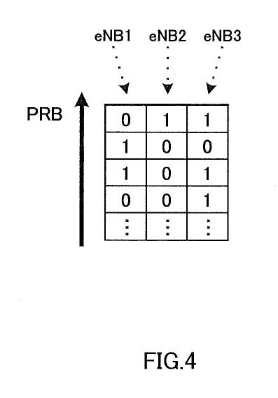

FIG. 4 shows an example of radio resource allocation information in example 1 of the radio communication control method according to the present embodiment. In FIG. 4, the central control station sends reports to radio base station eNB 1, and bit sequences to show the muted state (represented by “0”)/normal state (represented by “1”) of three radio base station (eNB 1 to eNB 3) including neighboring radio base stations eNB 2 and eNB 3 on a per PRB basis are shown as an example of reporting information. Also, in this case, to indicate to which one of eNB 1 to eNB 3 the allocation information represented by each bit sequence pertains to, the central control station attaches identification information of the cell formed by each corresponding radio base station, and reports this to eNB 1.

Note that the bit sequence structure is not limited to the structure shown in FIG. 4. For example, it may be possible to represent the muted state with “1” and represent the normal state with “0.” Also, a structure may be used in which the central control station applies data compression to each bit sequence and the radio base stations decompress the compressed bit sequences, so that the amount of information to be reported might decrease. For example, for data compression, run-length compression and/or the like may be used.

Example 1 of the radio communication control method according to the present embodiment may be further divided into three examples, depending on which radio base stations are seen as neighboring radio base stations (examples 1.1 to 1.3).

In an example 1.1 of the radio communication control method according to the present embodiment, neighboring radio base stations refer to radio base stations that may cause interference against user terminals that are present in the cell that is formed by the radio base station to which a report is transmitted. To be more specific, radio base stations that might cause interference refer to radio base stations that are subject to channel state measurements in user terminals that are present in the cell (that is, included in the measurement set).

In an example 1.2 of the radio communication control method according to the present embodiment, neighboring radio base stations refer to radio base stations where the distance from the radio base station to which a report is transmitted is equal to or shorter than a predetermined threshold, in addition to the condition of example 1.1. Note that the predetermined threshold distance is determined in the central control station. Also, it is preferable to determine the threshold depending on the load of communication. For example, when the load of communication is heavy, it is preferable to make the threshold large.

In an example 1.3 of the radio communication control method according to the present embodiment, neighboring radio base stations are radio base stations that are included in the measurement sets of two or more user terminals present in the cell formed by the radio base station to which a report is transmitted, in addition to the condition of example 1.1.

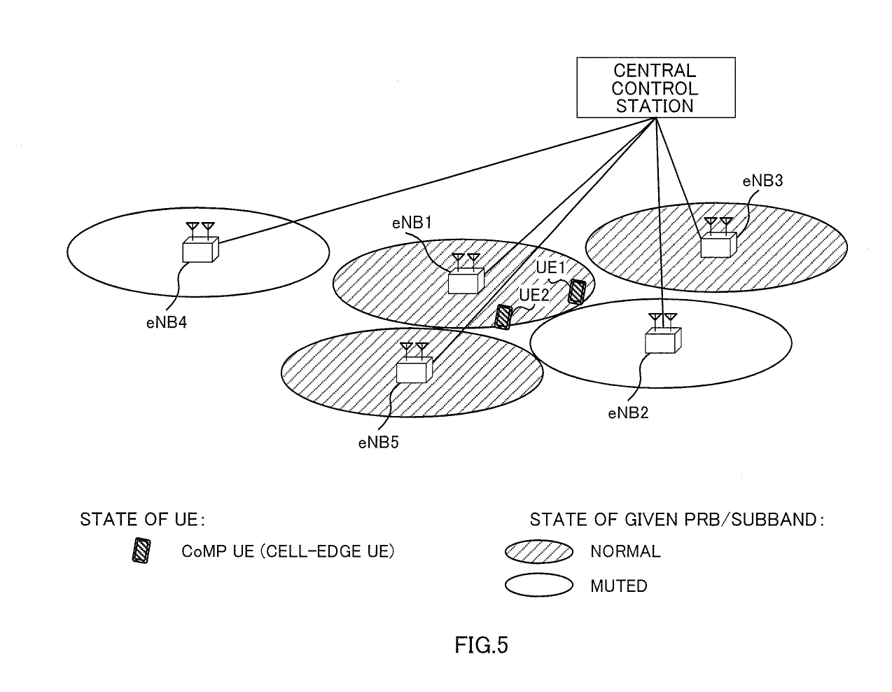

Now, a specific example of example 1 will be described below with reference to FIG. 5. FIG. 5 is a diagram to show an example of a network structure where the radio communication control method according to the present embodiment is employed. In FIG. 5, in addition to the structure of FIG. 3, UE 2, which is subject to CoMP, is present in the cell formed by eNB 1.

The assumptions in this example will be described below. First, the measurement set of UE 1 is eNB 1, eNB 2 and eNB 3. Also, the measurement set of UE 2 is eNB 1, eNB 5 and eNB 2. Also, as for the distance between eNB 1 and each eNB, between eNB 1 and eNB 5 is 20 m, between eNB 1 and eNB 2 is 26 m, between eNB 1 and eNB 3 is 31 m, and between eNB 1 and eNB 4 is 35 m. Also, the predetermined threshold distance is 30 m according to example 1.2. Also, cell IDs are used as cell identification information.

According to example 1.1, the central control station selects eNB 2, eNB 3 and eNB 5 included in the measurement set of UE 1 or UE 2, as radio base stations that might cause interference against cell-edge UEs (UE 1 and UE 2) under eNB 1. Consequently, the central control station reports, together with the cell IDs of the four cells formed by eNB 1, eNB 2, eNB 3 and eNB 5, four bit sequences to show the muted state/normal state of every physical resource block pertaining to these four radio base stations, to eNB 1.

Also, according to example 1.2, among the radio base stations that might cause interference against cell-edge UEs, the central control station selects eNB 2 and eNB 5 as being radio base stations within a threshold (30 m) from eNB 1. Consequently, along with the cell IDs of the three cells formed by eNB 1, eNB 2 and eNB 5, the central control station reports three bit sequences to show the muted state/normal state of every physical resource block pertaining to the three radio base stations, to eNB 1.

Also, according to example 1.3, among radio base stations that might cause interference against cell-edge UEs, the central control station selects eNB 2 as being a radio base station included in the measurement sets of both UE 1 and UE 2. Consequently, along with the cell IDs of the two cells formed by eNB 1 and eNB 2, the central control station reports two bit sequences to show the muted state/normal state of every physical resource block pertaining to the two radio base stations, to eNB 1.

Note that radio resource allocation information of neighboring radio base stations changes depending on the number of users that are subject to CoMP, the number of radio base stations to constitute CoMP, and so on. Consequently, it is preferable to configure the maximum number of bit sequences to constitute the radio resource allocation information of neighboring radio base stations. To be more specific, considering general cell deployment, it is preferable to make the maximum number of bit sequences “8.” Also, for the number of bit sequences, it is preferable to use “2” or “3” on a fixed basis, considering the signaling overhead, the measurement set size in user terminals and so on.

Also, although cell IDs have been described as an example of cell identification information to be associated and reported with the radio resource allocation information of neighboring radio base stations, this is by no means limiting. For example, it is possible to employ a structure to associate cell IDs and predetermined numbers with each other, share this information between the central control station and radio base stations in advance, and report these predetermined numbers, instead of cell IDs, along with radio resource allocation information. Also, the radio base station to which this report is directed can determine which neighboring radio base station the radio resource allocation information corresponds to, based on the timing the radio resource allocation information is reported from the central control station (for example, a predetermined time).

As described above, with example 1 of the radio communication control method according to the present embodiment, the central base station reports, to each radio base station, radio resource allocation information of neighboring radio base stations, along with identification information of the cells formed by these neighboring radio base stations. By this means, when CSI is fed back from a user terminal that is subject to CoMP, each radio base station can properly determine what signals were multiplexed in the radio resource that was measured to derive the CSI, with reference to the above radio resource allocation information of neighboring radio base stations, and carry out adequate scheduling and data modulation for the user terminal.

### Example 2

With an example 2 of the radio communication control method according to the present embodiment, the central control station reports, as information about radio resources allocated to neighboring radio base stations that carry out CoMP transmission, information about the state of interference in the radio base station per physical resource block or per subband, to a radio base station. In example 2, the radio base station to which this report is directed can properly judge whether neighboring radio base stations are transmitting signals in given radio resources, and, when CSI is fed back from a user terminal, properly judge what signals were multiplexed in the radio resource that was measured to derive the CSI.

Here, information about the state of interference in a radio base station refers to information about the interference which the radio base station receives from neighboring radio base stations. In example 2, for example, when CSI is fed back from a user terminal to the radio base station, signals from how many neighboring radio base stations among a plurality of neighboring radio base stations interfered with the radio resource that was measured to derive the CSI is learned by using the above information regarding the state of interference, and then the CSI is evaluated by making an assumption as to which specific neighboring radio base stations are causing interference. That is, with example 2, it is possible to estimate the allocation of radio resources in neighboring radio base stations according to example 1, by using information about the state of interference in a radio base station to which a report is directed.

Also, with example 2, it is not necessary to report information pertaining to neighboring radio base stations, so that it is possible to reduce the communication overhead involved in the reporting, compared to example 1. Note that example 2 can also employ a structure to report cell identification information (for example, cell IDs) to radio base stations.

In example 2, it is preferable to share the relationships between interference states and the information to report in advance between the central control station and the radio base stations. Note that these relationships can be changed as appropriate depending on the number of radio base stations to carry out CoMP transmission, the number of UEs present in the cells, the performance of the radio base stations, and so on. For example, the number of bits of information representing the state of interference in one PRB/subband may be selected from arbitrary natural numbers. Also, it is possible to update these relationships at predetermined timings by means of higher layer signaling.

Example 2 of the radio communication control method according to the present embodiment can be divided into four examples (examples 2.1 to 2.4).

With an example 2.1 of the radio communication control method according to the present embodiment, information about the state of CoMP is provided as information about the radio resources of neighboring radio base stations. As for the state of CoMP, for example, a muted state, a non-CoMP transmission state, a CoMP transmission state 1, a CoMP transmission state 2 and so on are stipulated in advance, and information to indicate which CoMP state applies is generated per PRB/subband. A radio base station to which a report is directed identifies the above states as follows, with respect to each PRB/subband. First, if the muted state is shown, the radio base station recognizes that no user terminal is scheduled in the corresponding PRBs/subbands. Also, in the non-CoMP transmission state, the radio base station recognizes that signals are transmitted from the subject station alone. In the CoMP transmission state 1, the radio base station recognizes that one neighboring radio base station is muted while the subject station transmits signals. In the CoMP transmission state 2, the radio base station recognizes that two neighboring radio base stations are muted while the subject station transmits signals. However, the CoMP states shown here are by no means limiting, and it is equally possible to stipulate and use other CoMP states as well.

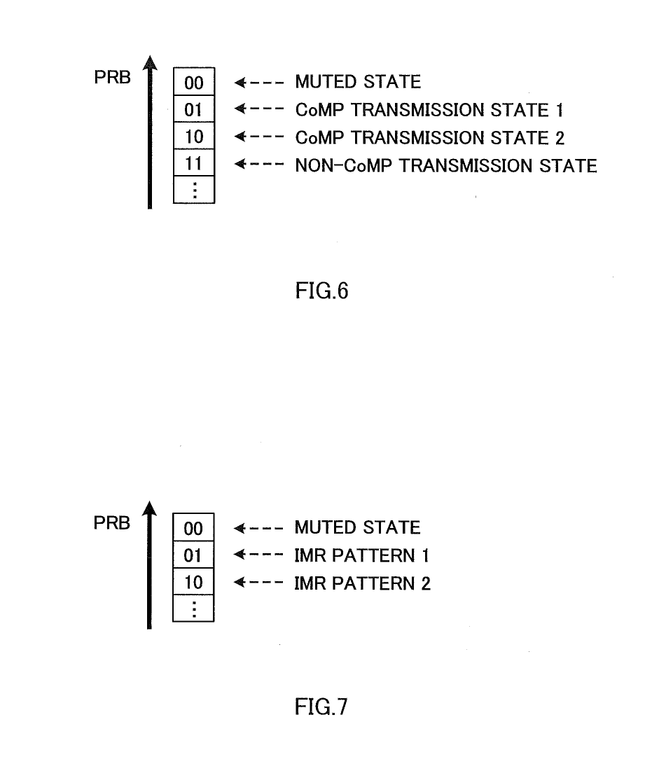

FIG. 6 shows an example of the information about radio resources in example 2.1 of the radio communication control method according to the present embodiment. In FIG. 6, the muted state is represented by “00,” the CoMP transmission state 1 is represented by “01,” the CoMP transmission state 2 is represented by “10,” and the non-CoMP transmission state is represented by “11,” and a bit sequence to include these pieces of information is illustrated.

In an example 2.2 of the radio communication control method according to the present embodiment, the information about the radio resources of neighboring radio base stations is information about the CSI process. Also, in example 2.2, a CSI process refers to the combination of a CSI-RS resource (SMR) and a CSI-IM resource (IMR), as mentioned earlier.

To help understand example 2.2, the configuration of the CSI process will be briefly described. Here, description will be given assuming that there are two transmission points (TP #1 and TP #2) in CoMP transmission. First, a radio resource where only the signal of TP #1 is allocated will be referred to as SMR #1. Also, a radio resource where the signals of both TP #1 and TP #2 are allocated will be referred to as SMR #2. Also, a radio resource where only the signal of TP #2 is allocated will be referred to as IMR #1. Also, a radio resource where no signal of TP #1 or TP #2 is allocated will be referred to as IMR #2. In this case, as CSI processes, for example, it is possible to make the combination of SMR #1 and IMR #1 CSI process #1, the combination of SMR #1 and IMR #2 CSI process #2, and the combination of SMR #2 and IMR #2 CSI process #3. By changing between and scheduling the CSI processes in a UE, the UE can measure a plurality of types of desired signal received power and interference signal received power.

Now, in example 2.2, for example, a muted state, a CSI process state 1, a CSI process state 2 and so on are stipulated in advance, and information to indicate which CSI process applies is generated per PRB/subband, as information about the CSI process. For example, when CSI process state 1 is reported, a radio base station can recognize that above-noted CSI process #1 is used in a given PRB/subband.

In an example 2.3 of the radio communication control method according to the present embodiment, information about the radio resources of neighboring radio base stations is information about the interference measurement resource pattern. For interference measurement resource patterns, allocation patterns of IMR radio resources such as those described above can be used, whereupon for example, as such patterns, an interference measurement resource pattern 1, an interference measurement resource pattern 2 and so on are stipulated in advance, and information to indicate which interference measurement resource pattern applies is generated per PRB/subband. For example, when the interference measurement resource pattern 1 is reported, a radio base station can recognize that the interference signal power in a cell apart from eNB 1 is measured in a given PRB/subband. Also, for example, when the interference measurement resource pattern 2 is reported, the radio base station can recognize that the interference signal power in a cell apart from eNB 1 and eNB 2 is measured in a given PRB/subband.

FIG. 7 shows an example of information about radio resources in an example 2.3 of the radio communication control method according to the present embodiment. In FIG. 7, the muted state is represented by “00,” the interference measurement resource pattern 1 is represented by “01,” and the interference measurement resource pattern 2 is represented by “10,” a bit sequence to include these pieces of information is illustrated.

In an example 2.4 of the radio communication control method according to the present embodiment, information about the radio resources of neighboring radio base stations is information about the zero-power CSI-RS pattern. As for the zero-power CSI-RS pattern, a zero-power CSI-RS pattern 1, a zero-power CSI-RS pattern 2 and so on are stipulated in advance based on CSI-RS allocation information and the zero-power CSI-RS configuration, and information to indicate which zero-power CSI-RS pattern applies is generated per PRB/subband. For example, when the zero-power CSI-RS pattern 1 is reported, a radio base station can recognize that a given PRB/subband is a radio resource where the CSI-RS is muted by above-noted IMR #1.

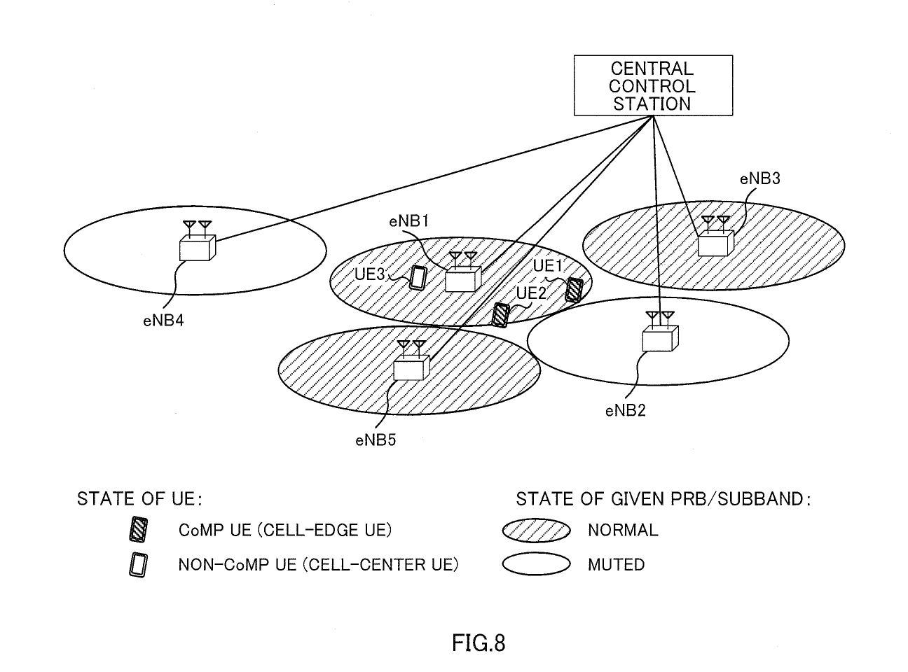

A specific example of example 2 will be described with reference to FIG. 8. FIG. 8 is a diagram to show an example of a network structure in which the radio communication control method according to the present embodiment is employed. In FIG. 8, in addition to the structure of FIG. 5, a UE 3, which is subject to non-CoMP, is present in the cell (near the center of the cell) formed by eNB 1.

The assumptions in FIG. 8 will be described below. First, the measurement set of UE 1 is eNB 1, eNB 2 and eNB 3. Also, the measurement set of UE 2 is eNB 1, eNB 5 and eNB 2. Also, UE 1 can return the following four types of CSI (CSI 1 to CSI 4). CSI 1 is the CSI for use in the non-CoMP transmission state (single-cell communication), and, for example, the CSI for radio resources where eNB 1, eNB 2 and eNB 3 are in the normal state. Also, CSI 2 is the CoMP CSI for radio resources where eNB 1 is in the normal state, eNB 2 is in the muted state and eNB 3 is in the normal state. Also, CSI 3 is the CoMP CSI for radio resources where eNB 1 and eNB 2 are in the normal state and eNB 3 is in the muted state. Also, CSI 4 is the CoMP CSI for radio resources where eNB 1 is in the normal state and eNB 2 and eNB 3 are in the muted state. Also, UE 2 can return four types of CSI (CSIa to CSId). CSIa to CSId replace eNB 2 and eNB 3 in the above description of CSI 1 to CSI 4 with eNB 5 and eNB 2, respectively.

The process which eNB 1, having received reporting information, performs upon receiving CSI feedback from a user terminal will be described below. First, the case of example 2.1 will be described assuming the four patterns shown in FIG. 6.

In this case, in a PRB corresponding to the muted state (“00”), there is likely to be interference against nearby cells of eNB 1, and therefore eNB 1 schedules no radio resource with respect to this PRB.

Also, when deciding that CSI to correspond to a PRB having been transmitted in the CoMP transmission state 1 (“01”) has been received, eNB 1 first decides which of the CSIs fed back from UE 1 or UE 2 will be used. When the result of this decision is UE 1, eNB 1 contemplates carrying out scheduling and data modulation assuming both CSI 2 and CSI 3, and carries out scheduling and data modulation for UE 1 using the more preferable one. Also, when the result of this decision is UE 2, eNB 1 contemplates CSIb and CSIc, and carries out scheduling and data modulation for UE 2 using the more preferable one.

Also, when deciding that CSI to correspond to a PRB having been transmitted in the CoMP transmission state 2 (“10”) has been received, eNB 1 first decides which of the CSIs fed back from UE 1 or UE 2 will be used. If the result of this decision is UE 1, this obviously leads to CSI 4, so that the scheduling and data modulation for UE 1 are performed based on CSI 4. Also, if the result of this decision is UE 2, this obviously leads to CSId, so that the scheduling and data modulation for UE 2 are performed based on CSId.

Also, when deciding that CSI to correspond to a PRB having been transmitted in the non-CoMP transmission state (“11”) has been received, eNB 1 first decides which of the CSIs fed back from UE 1, UE 2 and UE 3 will be used. If the result of this decision is UE 1, this obviously leads to CSI 1, so that the scheduling and data modulation for UE 1 are performed based on CSI 1. Also, if the result of this decision is UE 2, this obviously leads to CSIa, so that the scheduling and data modulation for UE 2 are performed based on CSIa. Also, if the result of this decision is UE 3, the scheduling and data modulation for UE 3 are performed based on this CSI.

Next, the case of example 2.3 will be described assuming the three patterns shown in FIG. 7.

In this case, eNB 1 works in the same way as in above example 2.1, based on PRBs corresponding to the muted state (“00”).

Also, when deciding that CSI to correspond to a PRB having been transmitted in the interference measurement resource pattern 1 (“01”) has been received, eNB 1 first decides which of the CSIs fed back from UE 1, UE 2 and UE 3 will be used. If the result of this decision is UE 1, this obviously leads to CSI 1, so that the scheduling and data modulation for UE 1 are performed based on CSI 1. Also, if the result of this decision is UE 2, this obviously leads to CSIa, so that the scheduling and data modulation for UE 2 are performed based on CSIa. Also, if the result of this decision is UE 3, the scheduling and data modulation for UE 3 are performed based on this CSI.

Also, when deciding that CSI to correspond to a PRB having been transmitted in the interference measurement resource pattern 2 (“10”) has been received, eNB 1 first decides which of the CSIs fed back from UE 1 and UE 2 will be used. If the result of this decision is UE 1, this obviously leads to CSI 2, so that the scheduling and data modulation for UE 1 are performed based on CSI 2. Also, if the result of this decision is UE 2, this obviously leads to CSIc, so that the scheduling and data modulation for UE 2 are performed based on CSIc.

As described above, with example 2 of the radio communication control method according to the present embodiment, the central base station reports, to each radio base station, information about the state of interference in that radio base station. By this means, when CSI is fed back from a user terminals that is subject to CoMP, each radio base station can properly judge what signals were multiplexed in the radio resource that was measured to derive the CSI, based on the information about the state of interference, and carry out appropriate scheduling and data modulation for the user terminal.

(Variation)

In examples 1 and 2, the information about the radio resources allocated to neighboring radio base stations may be structured to contain only information that corresponds to physical resource blocks showing the normal state in the radio base station to which this information is reported. As clear from the above-described examples, CSI that is based on PRBs corresponding to the muted state need not be taken into account, so that, when the radio base station is in the muted state, information about the neighboring radio base stations is not necessary. Consequently, when many of the radio resources of the radio base station to which the information is reported are in the muted state, it is possible to reduce the volume of communication involved in the reporting by applying this variation.

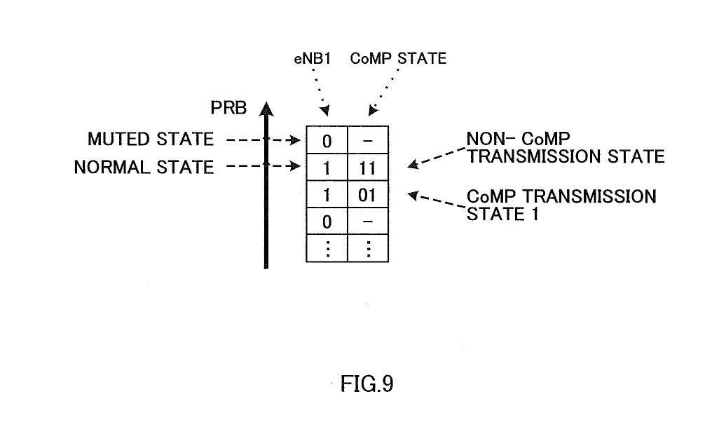

This structure will be described with reference to FIG. 9. FIG. 9 is a diagram to show an example of information about radio resources in a variation based on example 2.1 of the radio communication control method according to the embodiment. In FIG. 9, two bit sequences are illustrated. The left bit sequence is a bit sequence in which every one bit shows the muted state/normal state of every PRB in eNB 1, to which information is reported, and may be provided in the same format as the radio resource allocation information according to example 1. The right sequence provides information to represent the CoMP states shown in example 2.1. A structure is shown here in which a row that shows the muted state in the left sequence contains no information in the right sequence. Note that “-” in FIG. 9 indicates that no information is contained.

(Structure of Radio Communication System)

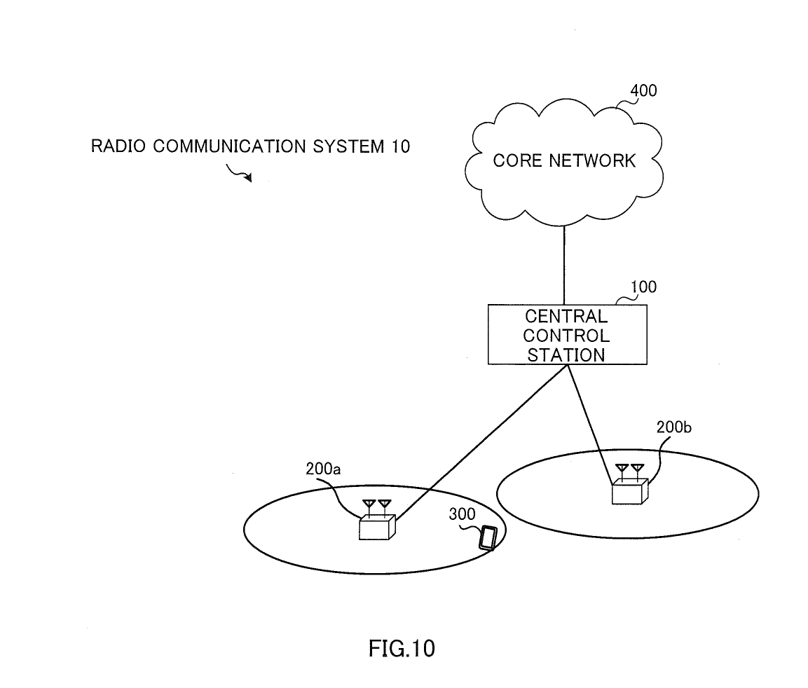

Now, a structure of a radio communication system according to the present embodiment will be described below. In this radio communication system, at least one of the above-described radio communication control methods (example 1 and example 2) is employed. A schematic structure of the radio communication system according to the present embodiment will be described with reference to FIG. 10.

FIG. 10 is a diagram to show an overall structure of the radio communication system according to the present embodiment. Note that the radio communication system 10 shown in FIG. 10 is a system to incorporate, for example, the LTE system, the LTE-A system, IMT-advanced, 4G, FRA (Future Radio Access) and so on.

As shown in FIG. 10, the radio communication system 10 includes a central control station 100, radio base stations 200 (200a and 200b) and a user terminal 300. Also, the central control station 100 is connected to a core network 400. Note that the structure of the radio communication system according to the present embodiment is by no means limited to the structure shown in FIG. 10. For example, the radio base stations 200 may be connected via the X2 interface. Also, the number of radio base stations 200 and user terminals 300 is by no means limited to the example shown in FIG. 10.

The central control station 100 is connected with a plurality of radio base stations 200, and, performs CoMP control for a plurality of radio base stations 200 all together, in a centralized control structure. The central control station 100 may be, for example, an access gateway apparatus, a radio network controller (RNC), a mobility management entity (MME) and so on, but is by no means limited to these. Also, if a radio base station 200 has the functions of the central control station 100, it is possible to use this radio base station 200 instead of the central control station 100.

The radio base stations 200 communicates with the serving user terminal 300 in accordance with control information that is reported from the central control station 100. The radio base stations 200 have scheduling functions, and can allocate signals for the user terminal 300 to given radio resources. Also, the radio base stations 200 can execute CoMP transmission, with other radio base stations that form neighboring cells, with respect to the serving user terminal 300. Also, scheduling, data modulation and so on are performed based on radio resource allocation information that is reported from the central control station 100 and CSI that is fed back from the user terminal 300.

With the radio base stations 200 in the present embodiment, how big the coverage areas of the cells formed is not an issue. For example, a radio base station 200 may be a radio base station (macro base station) to form a cell having a relatively wide coverage (macro cell). Also, a radio base station 200 may be a radio base station (small base station) to form a cell having a local coverage (small cell). Note that a macro base station may be referred to as a “MeNB (Macro eNodeB),” a “transmission point,” an “eNodeB (eNB),” and so on. Also, a small base station may be referred to as an “SeNB (Small eNodeB),” an “RRH (Remote Radio Head),” a “pico base station,” a “femto base station,” a “home eNodeB,” a “transmission point,” an “eNodeB (eNB),” and so on.

The user terminal 300 is a terminal to support various communication methods such as LTE, LTE-A, FRA and so on, and is capable of communicating with the radio base stations 200 on its own. Also, the user terminal 300 has functions which a normal user terminal should have. For example, the user terminal 300 has a transmitting/receiving antenna, an amplifying section, a transmitting/receiving section, a baseband signal processing section, an application section and so on. Note that the user terminal 300 may not only be a mobile communication terminal, but may also be a stationary communication terminal as well.

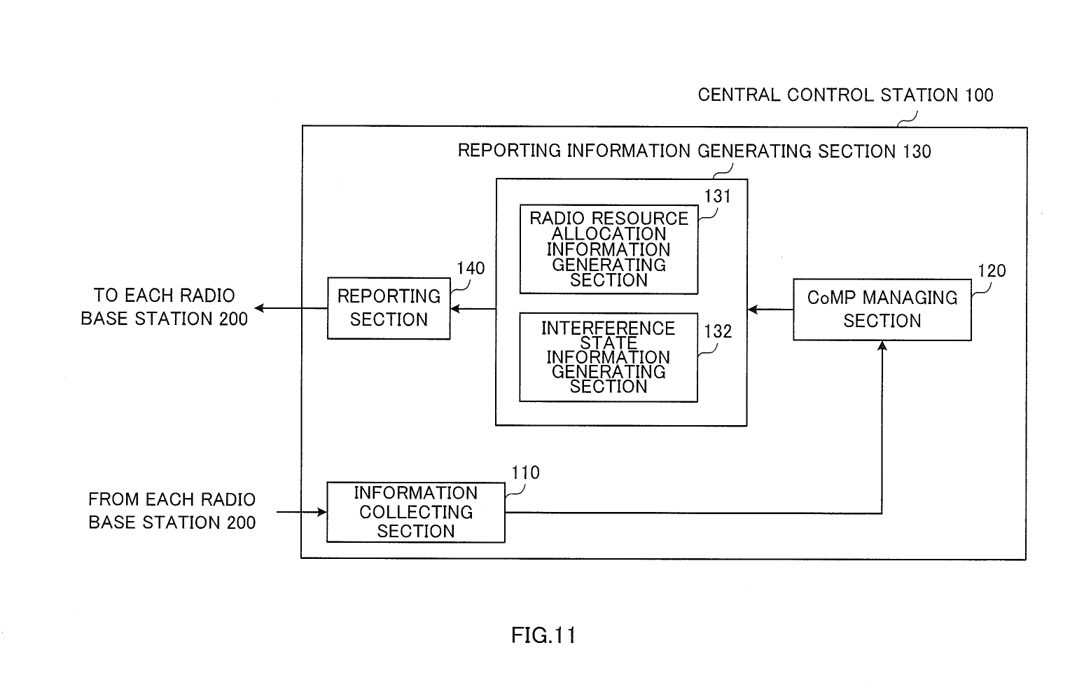

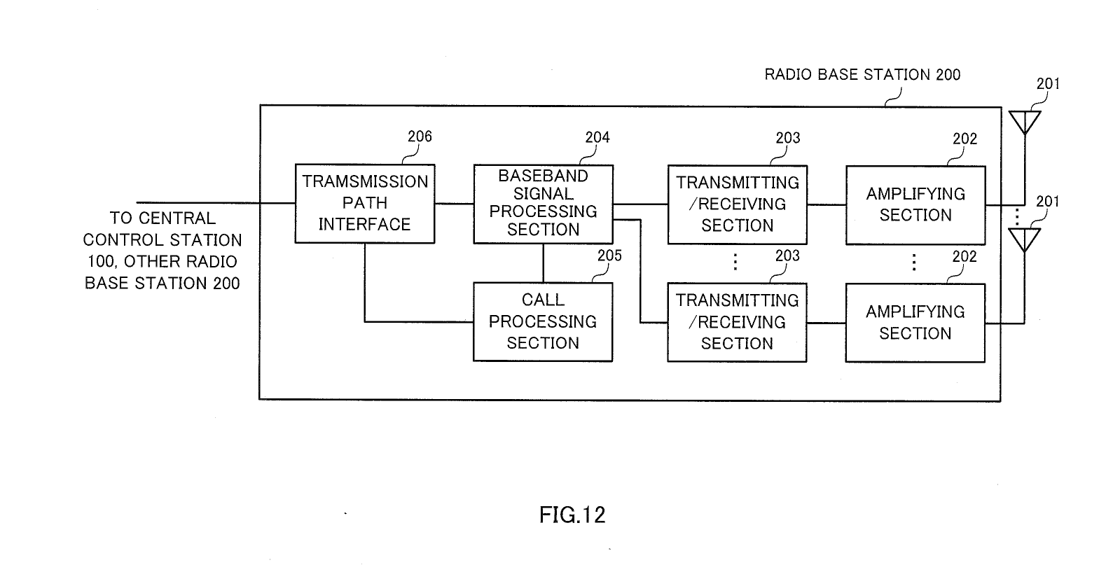

Now, the structures of the central control station 100 and the radio base stations 200 according to the present embodiment will be described with reference to FIGS. 11 and 12.

FIG. 11 is a block diagram to show an example structure of the central control station according to the present embodiment. Note that, although FIG. 11 shows part of the structure, the central control station 100 has configurations that are required in the centralized control structure for CoMP transmission, without shortage.

The central control station 100 has an information collecting section 110, a CoMP managing section 120, a reporting information generating section 130 and a reporting section 140.

The information collecting section 110 collects CoMP-related information from each radio base station 200, and outputs the resulting information to the CoMP managing section 120. For example, information such as the cell IDs of the cells formed by the radio base stations, the number of user terminals that serve under the radio base stations, CSI that is fed back from user terminals and so on are collected. Note that information that is not directly related to CoMP may be collected as well.

The CoMP managing section 120 manages the CoMP state of each radio base station based on the information input from the information collecting section 110. For example, for a plurality of radio base stations 200, whether or not to apply CoMP is determined taking into account the channel states with respect to the serving user terminals, the cell areas and so on. Also, the radio resources for use of each radio base stations 200 are allocated.

The reporting information generating section 130 includes a radio resource allocation information generating section 131 and an interference state information generating section 132. Based on the radio resources allocated by the CoMP managing section 120 for use for each radio base stations 200, the reporting information generating section 130 generates information about radio resources allocated to neighboring radio base stations, with respect to each radio base station, and outputs the generated information to the reporting section 140.

Based on the radio resources determined in the CoMP managing section 120 to be provided for use for each radio base station 200, the radio resource allocation information generating section 131 generates radio resource allocation information, and outputs this to the reporting section 140. For the radio resource allocation information, for example, a bit sequence to represent the muted state/normal state of each physical resource block (PRB) with one bit can be used.

Also, in example 1 of the radio communication control method according to the present embodiment, the radio resource allocation information generating section 131 attaches identification information (for example, cell IDs) of the cells formed by neighboring radio base stations of the radio base station to which the above information is reported, and outputs radio resource allocation information of these neighboring radio base stations to the reporting section 140. Note that the cell identification information can be acquired from the CoMP managing section 120.

Here, the information that is generated varies depending on which of the radio base stations that might cause interference against the radio base station to which the information is reported are seen as neighboring radio base stations. The radio resource allocation information generating section 131 can see radio base stations that are subject to channel state measurements (that is, included in the measurement set) in user terminals that are present in the cell of the radio base station to which the information is reported, and generate radio resource allocation information of these neighboring radio base stations (example 1.1).

Also, in addition to the condition of example 1.1, the radio resource allocation information generating section 131 can see radio base stations where the distance from the radio base station to which the information is reported is equal to or shorter than a predetermined threshold as neighboring radio base stations, and generate radio resource allocation information of these neighboring radio base stations (example 1.2). Information about the distance between the radio base stations is held in the CoMP managing section 120. Note that this threshold distance may be determined in the CoMP managing section 120 based on environment factors such as the load of communication.

Also, in addition to the condition of example 1.1, the radio resource allocation information generating section 131 can see radio base stations that are included in the measurement sets of two or more user terminals present in the cell formed by the radio base station to which information is reported as neighboring radio base stations, and generate radio resource allocation information of these neighboring radio base station (example 1.3).

Based on the radio resources determined in the CoMP managing section 120 for use by each radio base station 200, the interference state information generating section 132 generates information about the state of interference in each radio base station 200. For the information about the state of interference, information about the state of CoMP (example 2.1), information about the CSI process (example 2.2), information about the interference measurement resource pattern (example 2.3), or information about the zero-power CSI-RS pattern (example 2.4) can be used.

Note that, when information to report to the radio base stations 200 is generated ad reported in accordance with example 1 alone, it is possible to employ a structure which includes no interference state information generating section 132.

When information about radio resources allocated to neighboring radio base stations with respect to a given radio base station is received as input from the reporting information generating section 130, the reporting section 140 reports this information to the radio base station. When radio resource allocation information that is directed to a given radio base station is received as input from the radio resource allocation information generating section 131, the reporting section 140 attaches identification information of the cells formed by neighboring radio base stations of that radio base station, and these pieces of information to the radio base station.

FIG. 12 is a block diagram to show an example structure of a radio base station according to the present embodiment. As shown in FIG. 12, the radio base station 200 according to the present embodiment has a plurality of transmitting/receiving antennas 201, amplifying sections 202, transmitting/receiving sections 203, a baseband signal processing section 204, a call processing section 205 and a communication path interface 206.

User data to be transmitted from the radio base station 200 to a user terminal 300 on the downlink is input from central control station 100 to the baseband signal processing section 204, via transmission path interface 206.

In the baseband signal processing section 204, the user data that is input is subjected to a PDCP (Packet Data Convergence Protocol) layer process, division and coupling of user data, RLC (Radio Link Control) layer transmission processes such as an RLC retransmission control transmission process, MAC (Medium Access Control) retransmission control (for example, an HARQ (Hybrid ARQ) transmission process, scheduling, transport format selection, channel coding, a DFT (Discrete Fourier Transform) process, an IFFT (Inverse Fast Fourier Transform) process, a precoding process and so on, and the result is forwarded to each transmitting/receiving section 203. Furthermore, downlink control signals are also subjected to transmission processes such as channel coding and an inverse fast Fourier transform, and the result is forwarded to each transmitting/receiving section 203.

Each transmitting/receiving section 203 converts the downlink signals, pre-coded and output from the baseband signal processing section 204 on a per antenna basis, into a radio frequency band. The amplifying sections 202 amplify the radio frequency signals having been subjected to frequency conversion, and transmit the resulting signals via a plurality of transmitting/receiving antennas 201, to a plurality of user terminals, while applying space division multiplexing. Note that transmitting/receiving antennas 201 are preferably formed with multiple antennas for MIMO (Multi Input Multi Output) communication, but can be formed with one antenna as well.

On the other hand, as for uplink signals, radio frequency signals that are received in the transmitting/receiving antennas 201 are each amplified in the amplifying sections 202, converted into baseband signals through frequency conversion in each transmitting/receiving section 203, and input into the baseband signal processing section 204.

In the baseband signal processing section 204, user data that is included in the baseband signals that are input is subjected to an FFT (Fast Fourier Transform) process, an IDFT (Inverse Discrete Fourier Transform) process, error correction decoding, a MAC retransmission control receiving process, and RLC layer and PDCP layer receiving processes, and the result is forwarded to the central control station via the transmission path interface 206. The call processing section 205 performs call processing such as setting up and releasing communication channels, manages the state of the base station and manages the radio resources.

Also, the baseband section 204 has an acquisition section. The acquisition section acquires information about radio resources allocated to neighboring radio base stations, from the central control station 100. Also, the acquisition section acquires channel state information from the user terminal 300.

Also, the baseband section 204 has a decision section. The decision section decides, based on the information about radio resources allocated to neighboring radio base stations acquired in the acquisition section, whether or not the user terminal received interference from these neighboring radio base station when the user terminal measured the channel state information that was acquired in the acquisition section.

Also, based on the above decision, the baseband signal processing section 204 determines what signals were multiplexed in the radio resource which the user terminal 300 measured to derive the CSI that was fed back. Then, radio resource scheduling and data modulation for the user terminal 300 is performed based on the radio resource allocation information reported form the central control station 100 and the above CSI.

Note that it is also possible to employ a structure in which the information collecting section 110, the CoMP managing section 120, the reporting information generating section 130 and the reporting section 140 are provided in a radio base station 200, not the central control station 100. In this case, this radio base station 200, instead of the central control station 100, can control the allocation of radio resources to each radio base station 200, and generate and report information about radio resources allocated to neighboring radio base stations.

As described above, with the radio communication system according to the present embodiment, the central base station reports radio resource allocation information of neighboring radio base stations, along with identification information of the cells formed by these neighboring radio base stations (example 1), to each radio base station, or reports information about the state of interference in that radio base station (example 2). By this means, when CSI is fed back from a user terminal that is subject to CoMP, each radio base station can properly judge what signals were multiplexed in the radio resource that was measured to derive the CSI, and carry out appropriate scheduling and data modulation for the user terminal.

Now, although the present invention has been described in detail, it should be obvious to a person skilled in the art that the present invention is by no means limited to the embodiment described herein. The present invention can be implemented with various corrections and in various modifications, without departing from the spirit and scope of the present invention defined by the recitations of claims. Consequently, the description herein is only provided for the purpose of illustrating examples, and should by no means be construed to limit the present invention in any way.

The disclosure of Japanese Patent Application No. 2013-227412, filed on Oct. 31, 2013, including the specification, drawings and abstract, is incorporated herein by reference in its entirety.

1. A central control station that is connected with a plurality of radio base stations that carry out coordinated multi-point transmission to a user terminal, the central control station comprising:
a reporting information generating section that generates, for each radio base station, information about a radio resource allocated to another radio base station that carries out coordinated multi-point transmission; and
a reporting section that reports the information about the radio resource, generated in the reporting information generating section, to each radio base station.

2. The central control station according to claim 1, wherein the reporting section reports the information about the radio resource via an X2 interface.

3. The central control station according to claim 1, wherein:
the reporting information generating section comprises a radio resource allocation information generating section;
the radio resource allocation information generating section generates, as the information about the radio resource, radio resource allocation information that shows a muted state/normal state of every physical resource block in the other radio base station; and
the reporting section reports the radio resource allocation information, along with identification information of a cell formed by the other radio base station.

4. The central control station according to claim 3, wherein the other radio base station is a radio base station whose channel state is measured in a user terminal that is present in a cell formed by a radio base station that is subject to the reporting from the reporting section.

5. The central control station according to claim 4, wherein the other radio base station is a radio base station whose distance from a radio base station that is subject to the reporting from the reporting section is equal to or shorter than a predetermined threshold.

6. The central control station according to claim 4, wherein the other radio base station is a radio base station whose channel state is measured in two or more user terminals that are present in the cell formed by the radio base station that is subject to the reporting from the reporting section.

7. The central control station according to claim 1, wherein:
the reporting information generating section comprises an interference state information generating section;
the interference state information generating section generates, as the information about the radio resource, information about a state of interference in the radio base station that is subject to the reporting from the reporting section per physical resource block or subband; and
the reporting section reports the information about the state of interference.

8. The central control station according to claim 1, wherein the information about the radio resource includes only information that corresponds to physical resource blocks that are in the normal state in the radio base station that is subject to the reporting from the reporting section.

9. A radio base station that is connected with a central control station and carries out coordinated multi-point transmission to a user terminal, the radio base station comprising:
an acquisition section that acquires information about a radio resource allocated to another radio base stations that carries out coordinated multi-point transmission from the central control station, and acquires channel state information from the user terminal; and
a decision section that decides, based on the information about the radio resource allocated to the other radio base station, whether or not the user terminal received interference from the other radio base station when measuring the channel station information.

10. A radio communication control method in a radio communication system in which a plurality of radio base stations carry out coordinated multi-point transmission to a user terminal, the radio communication control method comprising, in a central control station that is connected with the plurality of radio base stations, the steps of:
generating, for each radio base station, information about a radio resource allocated to another radio base station that carries out coordinated multi-point transmission; and
reporting the information about the radio resource that is generated, to each radio base station.
